(19) United States
(12) Patent Application Publication
(10) Pub. No.: US 2006/0229884 A1
(43) Pub. Date: Oct. 12, 2006

(54) Method for enabling a combination of several individual products to be identified clearly

(75) Inventors: Ralf Grundhoff, Bonn (DE); Volkmar Strauch, Vettelschoss (DE)

Correspondence Address: NORRIS, MCLAUGHLIN & MARCUS, 875 THIRD AVE, 18TH FLOOR, NEW YORK, NY, 10022, US

(73) Assignee: T-Mobile Deutschland GmbH, Bonn (DE)

(21) Appl. No.: 10/548,787

(22) PCT Filed: Mar. 11, 2004
(86) PCT No.: PCT/DE04/00486

§ 371 Date: May 5, 2006

(30) Foreign Application Priority Data
Mar. 11, 2003 (DE) 10310871.8

(51) Int. Cl. G06Q 99/00

(52) U.S. Cl. 705/1

(57) ABSTRACT

The invention relates to a method for enabling a combination of several individual products (product bundle) to be identified clearly in order to track said products according to the components thereof for the sale and premiumization thereof when said product bundle is purchased. The product bundle comprises a mobile radio terminal and SIM card. A clear material Number is allocated to the mobile radio terminal and a clear chip card Identification Number (U)ICC-ID is allocated to the SIM chip card. According to the inventive method, the mobile radio terminal and the chip card are combined with each other in an EAN data bank by means of the Material Number of the terminal (optionally IMEI) by means of a European Article Number (EAN) for said product bundle. Combination to form a new product makes it possible to market terminal-specific and/or service-specific packets with mobile radio cards in a package/bundle.

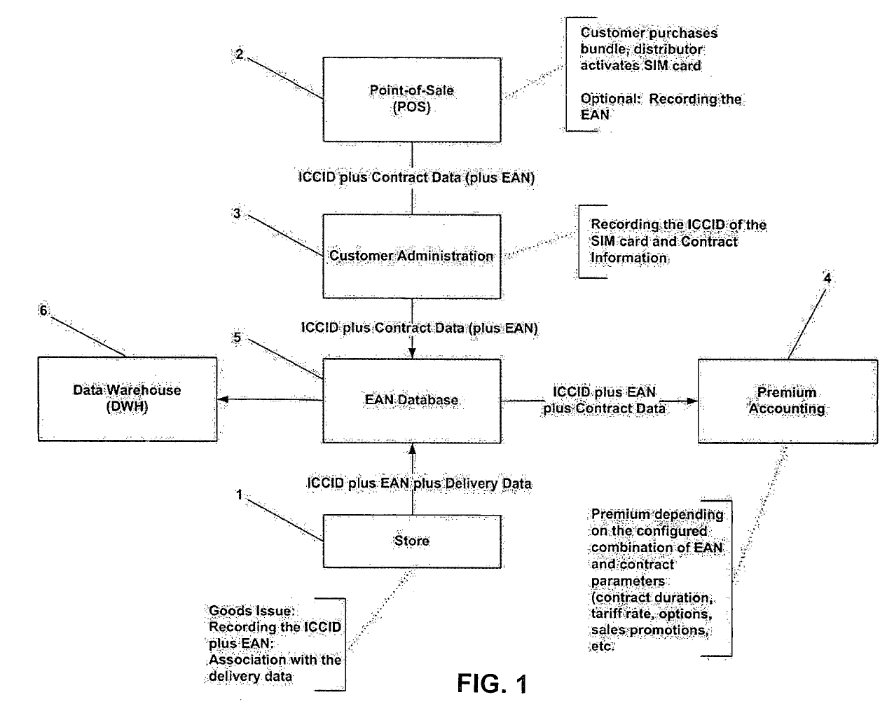

The invention relates to a method for enabling identification of a combination of several individual products (product bundle) for tracking product-component-dependent goods and for selling the combination, and for calculating a premium upon sale of the product bundle.

Product packages in the form of so-called bundles have existed in the mobile radio domain since some time. In particular, the sale of so-called prepaid services has provided experience with such bundles where, for example, the combination of a mobile radio terminal and a mobile radio card (SIM) are marketed as a package. Such bundle can typically be subsidized and therefore be offered at a lower price than the separate components, because the subsidized terminal already includes a SIM card of the network operator. However, the mobile terminal type and the mobile radio card and/or service/tariff are not linked. Disadvantageously, a package can then not be provisioned/subsidized in a differentiated manner according to the terminal type and/or the services or tariffs associated with the terminal. As a result, the subsidy provided, for example, commensurate with the value of the terminal can then not be allocated upon sale, and the network operator is unaware of the type of terminal purchased by the various customers. The network operator has also no specific information about the type of package that must be ordered later for a particular terminal (goods tracking). Different terminals can therefore be differentiated only in a very limited manner when using conventional methods for allocating and marketing the terminals.

It is known in mobile radio networks to record a so-called international mobile equipment identity (IMEI). The IMEI is a one-to-one, device-specific, electronic identification number of mobile radio terminals used in GSM networks. This number consists of a type code and a sequential, manufacturer-dependent product number. The IMEI is recorded in an Equipment Identity Register (EIR) of the mobile radio network, can be queried from the network and makes it possible, for example, to localize and disable registered devices that have been stolen. Disadvantageously, however, the IMEI is not linked to the SIM mobile radio card and tariffs/services. The IMEI itself may therefore become a commodity (fraud risk), if as part of the provisioning process. The so-called “purchased IMEI” is obtained by the dealer in a sales transaction in addition to the activation data. It can therefore not be guaranteed that the device was actually transferred to the customer, which can only be ascertained by querying the network (so-called “utilized IMEI”). However, this approach is questionable not only due to legal requirements for data protection, but this information is also not available at the time of the sales transaction, because the device would have to be in operation at the time of the sale.

SIM cards have a chip card identification number (IC-Card ID) ((U)ICC-ID+(U)ICC-UMTS cards), which is programmed into the chip already during manufacture and is unique for each chip card worldwide. In principle, this identification number can be read out at any time. However, the identification number is transmitted to the accounting systems not via the GSM network, but rather via the activation chain, and cannot be changed. The SIM serial number is used in the accounting system of the network operator as a reference number associated with a customer's data set. The customer associated with a chip card can be determined based on this association.

It is an object of the present invention, to link a chip card (SIM, (U)ICC) and a mobile radio terminal with each other in order to add to the sales transaction not only the activated tariffs, but also information about the terminal—optionally applicable to the tariff. There is also a need to optimize the committed capital for storing devices obtained from the manufacturer of the terminals through goods tracking. This should be quantifiable.

The object is solved by the invention by a method having the features of claim 1.

According to the invention, the terminal and the SIM-/(U)ICC mobile radio card, as well as certain optional (prospective and/or actually ordered) tariffs/services, are linked by associating the mobile radio card identification (U)ICC-IC and the material number of the terminal as a type identification of the terminal and by assigning a European Article Number (EAN code) for this type of the device combination in an EAN database. With this assignment, terminal-specific and/or services-specific packages can be marketed in conjunction with mobile radio cards as a package/bundle.

The European Article Number (EAN) is a bar-code standardized in Europe for acquiring product data with bar-code readers. EAN encoding is represented by a bar code having standardized manufacturer and country designations, and in addition with the manufacturer-specific article number and a test symbol. Stores can add to the EAN dedicated article identifications and prices, which are read by the server when the bar-code is scanned.

The product bundle includes a mobile radio terminal and a SIM-/(U)ICC card, whereby a material number is assigned to the mobile radio terminal as a type designation and a unique chip card identification number ((U)ICC-ID) is assigned to the SIM chip card. According to a preferred embodiment of the invention, the (U)ICC-ID of the chip card is obtained before delivery to a point-of-sale (POS) and the (U)ICC-ID is stored together with the delivery data (such as the material number) and the European Article Number (EAN) of this combination in a central EAN database.

When a customer signs a contract at a point-of-sale, the (U)ICC-ID of the chip card, the European Article Number (EAN) of the sold combination and the associated contract data are recorded. These data are transmitted from the point-of-sale to a database for customer administration, where they are stored. The data in the customer administration database are reconciled with the data in the EAN database based on the (U)ICC-ID and the contract data for the purpose of individual provisioning/subsidizing and goods tracking.

Advantageously, the EAN can be acquired at the point-of-sale by bar-code scanners.

According to the invention, the point-of-sale is not limited to stores, but can alternatively also be an online shop and the like.

The invention has the following advantages:

The terminal and the mobile radio card are linked for securing and controlling subsidies from the network operator.

Subsidies/sales provisioning of terminals can also be implemented according to the value of the terminal and/or the package.

Goods tracking, i.e., information about when, where and how many terminals of a certain type have been sold, is simplified. This reduces the committed capital and optimizes inventory utilization through more accurate planning.

For example, proprietary terminals and devices can be exclusively marketed through co-branding.

With this package, services and tariffs can also be marketed through bundling. For example, a sale is provisioned only when the package is sold with a specific tariff/service appropriate for the package and the terminal.

Terminal-specific and card-specific product configurations can be uniquely combined with each other (e.g., special SIM (U)ICC).

The trade takes advantage of warehousing based on the recorded EAN code in the goods management systems, while the network operator profits from the additional information in the (U)ICC-ID associated with an EAN code.

In addition, customer data relevant for marketing can be enriched. This enables the operator to segment customers, for example, according to the types of terminals and/or by analyzing socio-demographic information about customer purchasing habits regarding tariffs and terminals. The operator is then aware of, for example, the type of terminal purchased by certain types of customers.

One exemplary embodiment of the invention will now be described in detail with reference to the drawing. Additional features, advantages and applications of the invention can be inferred from the drawing and its description.

The drawing shows schematically the essential steps and devices for carrying out the method.

Execution of the method requires that the product, i.e., the physical bundle, includes at least one SIM card and one terminal. A unique EAN is associated with the respective product bundle. The SIM card includes exactly one (U)ICC-ID. Accordingly, exactly one (U)ICC-ID and an corresponding EAN can be associated with a contract number of a customer.

When a bundle is delivered from a warehouse 1, the (U)ICC-ID of the chip card together with a material number of the terminal are recorded, and this combination together with the delivery data is associated with an EAN.

The recorded data, i.e., the (U)ICC-ID, the EAN and the delivery data are stored together in an EAN database 5.

When a customer signs a mobile radio contract at a point-of-sale (2) and receives a bundle, the (U)ICC-ID of the SIM card and the EAN of the purchased bundle are registered in POS (2) in addition to the contract data (optionally, the IMEI of the terminal can also be obtained).

The (U)ICC-ID, the EAN and the contract data of the customer are transmitted from POS (2) to a database of a customer administration (3), where the (U)ICC-ID, the EAN and the contract data are stored.

The (U)ICC-ID, the EAN and the contract data are transmitted from the customer administration 3 to the EAN database (5), where the customer administration (3) data are reconciled with the existing data in the EAN database (5) based on the unique (U)ICC-ID.

The (U)ICC-ID, the EAN and the contract data can be used for premium accounting (4) depending on the configured combination, for example contract duration, tariff rate, options, sales promotions, etc.

The goods can be tracked and inventory monitored in a data warehouse (6) (DWH) based on the data stored in the EAN database. Data warehousing describes a process for optimizing information logistics with the goal to provide the correct information, extracted from a number of internal and external information sources, at the right time with the required performance, correctly processed, spontaneously and economically to the right addressee.

1-5. (canceled)

6. A method for enabling identification of a combination of several individual products, in form of a product bundle, for product-component-dependent tracking of goods and for selling this combination, the combination comprising at least one mobile radio terminal identified by its type and a SIM card which can be uniquely identified by a chip card identification number, ICC-ID or UICC-ID, wherein the type identification of the mobile radio terminal together with the chip card identification number of the SIM card are linked in a database and a European Article Number (EAN) is assigned to the combination as a new product, wherein each combination can be uniquely identified by the chip card identification number of the respective accompanying SIM card, the method including the steps of:
(a) recording the chip card identification number of the chip card before delivery to a point-of-sale (2) POS, and storing the chip card identification number together with the delivery data and the European Article Number, EAN, of the combination in a central EAN database (5);
(b) recording the chip card identification number of the chip card, the European Article Number, EAN, of the sold combination and the associated contract data when a customer signs the contract at a point-of-sale (2);
(c) transmitting these data from the point-of-sale (2) to a customer administration database (3) and storing to the chip card identification number and the European Article Number, EAN, together with the contract data in this customer administration database;
(d) transmitting these data to the EAN database (5); reconciling the data from the customer administration database (3) with the data of the EAN database (5) based on the chip card identification number;
(e) providing the chip card identification number, the contract data and the European Article Number, EAN, for individual premium accounting (4) and for goods tracking (6), wherein the data regarding tariff and services for the sale of each combination available at the signing of the contract are added to the data set of the respective combination in the form of an extension of the bundle by an additional service and/or tariff component.

7. The method according to claim 6, wherein at the point-of-sale (2) and when the goods are delivered, the IMEI is also recorded and likewise linked with the (U) ICC-ID.

8. The method according to one of the claim 6, wherein the point-of-sale is a store or an online shop.

9. The method according to one of the claim 7, wherein the point-of-sale is a store or an online shop.
